(19) United States
(12) Patent Application Publication
(10) Pub. No.: US 2022/0349206 A1
(43) Pub. Date: Nov. 3, 2022

(54) Bird Feeder Apparatus

(71) Applicant: Edmond Jay Burton, Newalla, OK (US)

(72) Inventor: Edmond Jay Burton, Newalla, OK (US)

(21) Appl. No.: 17/243,409

(22) Filed: Apr. 28, 2021

(51) Int. Cl. E04H 12/22; F16M 11/28; A01K 39/01

(52) U.S. Cl. CPC E04H 12/2223; F16M 11/28; A01K 39/01

(57) ABSTRACT

A bird feeder apparatus may have a retaining mechanism including a surface fastener coupled to a surface, a lower leveling bracket coupled to the surface fastener, and an upper leveling bracket coupled to the lower leveling bracket and the surface fastener. A stationary pole may be coupled to the retaining mechanism. The stationary pole may have one or more slots. A moving pole may be coupled to the stationary pole. The moving pole may be capable of movement, such as telescopic movement, with respect to the stationary pole. The moving pole may have a handle coupled to the moving pole and extending through the one or more slots.

### FIELD

The present disclosure generally relates to a bird feeding apparatus, and more particularly to a pole for suspending a bird feeding apparatus at a predetermined height.

### BACKGROUND

Bird feeders are commonly understood to be used to attract birds for the sport of bird watching. The position and/or orientation of the bird feeder may be an important consideration when deciding what birds to attract for the purpose of bird watching. Some birds may prefer a shorter pole. Some birds may prefer a longer pole. Some birds may prefer a more secluded setting, such as to be protected from predators. Some birds may prefer an open setting. Thus, those engaging in bird watching may install bird feeders at various positions and/or orientations to attract particular birds. Bird feeders may be installed at a height that deters other animals from accessing and eating the bird feed, such as squirrels and so forth.

Bird feeders may be installed at a height that makes them serviceable, e.g., such as to clean and/or refill the bird feeder periodically. Bird feeders installed at a height out of reach may be serviced with the use of a ladder to attain the height of the bird feeder, with a rod which reaches the height of the bird feeder, or by removing the bird feeder from its mounted position for servicing then remounting the bird feeder. Therefore, those engaging in bird watching may consider various positions and/or orientations to enable convenient servicing of the bird feeder. As many bird watchers are elderly, the convenience of servicing the bird feeder is paramount, due to the difficulty of using ladders and long poles. The difficulty of servicing bird feeders may be further increased by other environmental conditions, such as uneven ground, high wind, excessive moisture, and so forth.

Therefore, it would be desirable to overcome the above limitations in order to optimize position and/or orientation of the bird feeder and enable easier servicing of the bird feeder.

### SUMMARY

A bird feeder apparatus comprises a retaining mechanism configured to be coupled to a surface; a stationary pole coupled to the retaining mechanism, the stationary pole having one or more slots; and a moving pole coupled to the stationary pole, the moving pole capable of movement with respect to the stationary pole, the moving pole having a handle coupled to the moving pole and extending through the one or more slots.

A bird feeder apparatus comprises a moving pole; a stationary pole coupled to the moving pole, such that the moving pole is capable of movement with respect to the stationary pole; and a retaining mechanism including an upper leveling bracket coupled to the stationary pole, a lower leveling bracket coupled to the upper leveling bracket, and a surface fastener coupled to the upper and lower leveling brackets and to a surface, wherein the upper leveling bracket and the lower leveling bracket may be moved with respect to each other to level the bird feeder apparatus.

A bird feeder apparatus comprises a retaining mechanism including a surface fastener coupled to a surface, a lower leveling bracket coupled to the surface fastener, and an upper leveling bracket coupled to the lower leveling bracket and the surface fastener; a stationary pole coupled to the upper leveling bracket, the stationary pole having one or more slots; and a moving pole coupled to the stationary pole, the moving pole capable of movement with respect to the stationary pole, the moving pole having a handle coupled to the moving pole and extending through the one or more slots.

### BRIEF DESCRIPTION OF THE DRAWINGS

Various aspects and advantages will become apparent upon review of the following detailed description and upon reference to the drawings in which:

FIG. 1 illustrates a side view of a bird feeder pole;

FIG. 2A illustrates an isometric view of a bird feeder pole in a retracted position;

FIG. 2B illustrates an isometric view of a bird feeder pole in an extended position;

FIG. 3A illustrates an isometric view of a bird feeder pole in a retracted position;

FIG. 3B illustrates an isometric view of a bird feeder pole in an extended position;

FIG. 4A illustrates a cross-sectional view of a bird feeder pole unsecured by a locking handle;

FIG. 4B illustrates a cross-sectional view of a bird feeder pole secured by a locking handle;

FIG. 5A illustrates a cross-sectional view of a bird feeder pole in a retracted position;

FIG. 5B illustrates a cross-sectional view of a bird feeder pole in an extended position; and

FIG. 6 illustrates a retaining mechanism of a bird feeder pole.

### DETAILED DESCRIPTION

The following disclosure includes a method and apparatus for adjusting the position and/or orientation of a bird feeder apparatus by utilizing a bird feeder pole.

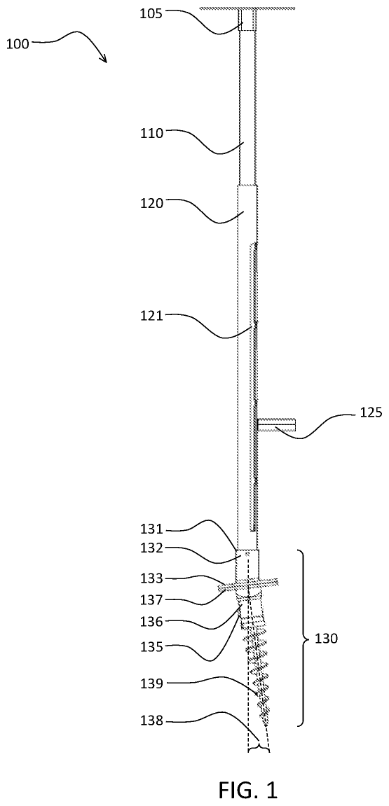

FIG. 1 illustrates a side view of a bird feeder apparatus 100. The apparatus 100 may include an inner pole 110 and an outer pole 120. The inner pole 110 and outer pole 120 may be configured to move with respect to each other, and may be configured to move translationally with respect to each other (e.g., telescopically). Outer pole 120 may be fixed in place (e.g., stationary), and inner pole 110 may be slidingly configured to outer pole 120. While the inner pole 110 is illustrated extending upwardly from within outer pole 120, this disclosure contemplates an alternative configuration where the outer pole 120 extends upwardly from without inner pole 110, and inner pole 110 is fixed in place.

As exemplified in FIG. 1, the stationary pole (e.g., outer pole 120) may be equipped with one or more slots 121. As exemplified in FIG. 1, the moving pole (e.g., inner pole 110) may be equipped with one or more locking handles 125. The one or more locking handles 125 may be secured to the moving pole through the one or more slots 121. The one or more locking handles 125 may be configured to engage the stationary pole and/or the one or more slots 121 to retain the moving pole with respect to the stationary pole. This disclosure also contemplates an arrangement where inner pole 110 is stationary and outer pole 120 moves. By showing the one or more slots 121 in the outer pole 120, the invention as represented in FIG. 1 is simplified for purposes of illustration.

The stationary pole (e.g., outer pole 120) may be connected to a retaining mechanism 130 (e.g., via a set screw, pin, screw, latch, clamp, adhesive, hook and loop fastening, threading, or other means of securement). Retaining mechanism 130 may include an upper leveling bracket 131, a lower leveling bracket 135, and a surface fastener 139. Surface fastener 139 may be configured to be secured to, interconnect with, or otherwise be retained on a surface (e.g., the ground, a wall, a roof, or other structure). Surface fastener 139 may be in the form of and/or operate as any one or more of an auger (as exemplified in FIG. 1), a ballast, a bracket, a clamp, a tie-down, a fitting, or any other known means for retaining the bird feeder apparatus 100 to a surface. Thus, surface fastener 139 may engage the surface (e.g., the auger being drilled into the ground).

After engagement with the surface, surface fastener 139 may be oriented at some angle 138 out of alignment with a longitudinal axis of the bird feeder apparatus 100. This misalignment may be intentional, may be due to imperfect engagement of surface fastener 139 with the surface, or a result of angular offset of the surface with the longitudinal axis of the bird feeder apparatus 100.

Nevertheless, retaining mechanism 130 may be configured to correct for some misalignment (e.g., between about 0 degrees and about 45 degrees of misalignment). Surface fastener 139 may be configured to be secured to, interconnect with, or otherwise be retained to the lower leveling bracket 135, and may share a common longitudinal axis with the lower leveling bracket 135. Lower leveling bracket 135 may be configured to be secured to, interconnect with, or otherwise be retained to the upper leveling bracket 131, and longitudinal axis of the lower leveling bracket 135 may be out of alignment with the upper leveling bracket 131 (e.g., by about 9 degrees). Upper leveling bracket 131 may be configured to be secured to, interconnect with, or otherwise be retained to the stationary pole (e.g., outer pole 120), and may share a common longitudinal axis with the stationary pole.

Upper leveling bracket 131 may be configured with a support portion 132 and a flanged portion 133. Support portion 132 may be configured to be secured to, interconnect with, or otherwise be retained to the stationary pole (e.g., outer pole 120). While outer pole 120 is exemplified as extending into an interior of support portion 132, this disclosure contemplates other configurations, such as where support portion 132 extends into an interior of the stationary pole (such as to improve weathering).

Lower leveling bracket 135 may be configured with a support portion 136 and a flanged portion 137. Support portion 136 may be configured to be secured to, interconnect with, or otherwise be retained to surface fastener 139. While surface fastener 139 is exemplified as extending into an interior of support portion 136, this disclosure contemplates other configurations, such as where support portion 136 extends into an interior of surface fastener 139.

Flanged portion 137 may extend in a plane perpendicular to and/or may be oriented perpendicularly to the longitudinal axis of lower leveling bracket 135 and/or the longitudinal axis of surface fastener 139. Flanged portion 133 may extend in a plane angularly offset from and/or may be oriented with an angular offset to the longitudinal axis of upper leveling bracket 131 (e.g., NOT perpendicular to the longitudinal axis of upper leveling bracket 131). The precise amount of this offset may correspond to angle 138, and may be configured to correct a particular amount of misalignment (e.g., between about 0 degrees and about 45 degrees of misalignment).

Flanged portion 133 of upper leveling bracket 131 may be configured to be secured to, interconnect with, or otherwise be retained to flanged portion 137 of lower leveling bracket 135. The means of securement may include any one or more of fasteners, adhesive, welding, clamping, or other means of securement. Thus, after securement of surface fastener 139 to the surface (e.g., the ground), the bird feeder apparatus 100 may be rotated (e.g., about its longitudinal axis) to an orientation that best aligns the longitudinal axis with a vertical axis, then flanged portion 133 may be secured to flanged portion 137 (e.g., causing the stationary pole to be secured to the surface).

A mounting plate 105 may be secured to the upper end of the moving pole (e.g., inner pole 110). Mounting plate 105 may facilitate attachment of a bird feeder, bird house, or other apparatus for attracting birds. While mounting plate 105 is illustrated as having a flat portion and a support portion secured to the moving pole, a person of ordinary skill in the art will appreciate that any configuration may be possible to form the mounting plate 105 with features to enable mounting of the bird feeder, bird house, or other apparatus for attracting birds.

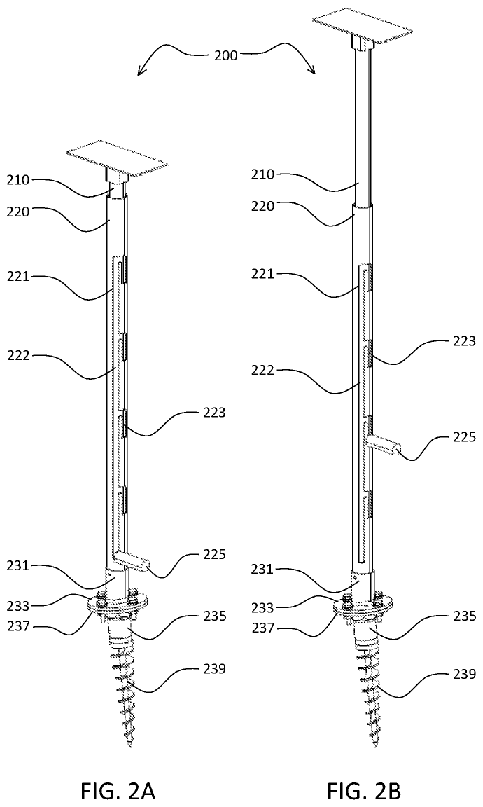

FIGS. 2A and 2B illustrate isometric views of a bird feeder apparatus 200 in a retracted position (e.g., as in FIG. 2A) and in an extended position (e.g., as in FIG. 2B). The apparatus 200 may include an inner pole 210 and an outer pole 220. The inner pole 210 and outer pole 220 may be configured to move with respect to each other, and may be configured to move translationally with respect to each other (e.g., telescopically). Outer pole 220 may be fixed in place (e.g., stationary), and inner pole 210 may be slidingly configured relative to outer pole 220. While inner pole 210 has been represented as the moving pole and outer pole 220 has been represented as the stationary pole, the inverse configuration is contemplated by this disclosure.

Outer pole 220 may be equipped with one or more slots 221. Slots 221 may extend from an outer surface of outer pole 220 to an inner surface of outer pole 220 (e.g., entirely through a side wall of outer pole 220). The one or more slots 221 may include a primary channel 222 and one or more secondary channels 223. Primary channel 222 may extend vertically along the bird feeder apparatus 200 and/or may extend along a longitudinal axis of the bird feeder apparatus 200. Primary channel 222 may be straight (e.g., as illustrated in FIGS. 2A and 2B), or may have some curvature (e.g., extending helically).

The one or more secondary channels 223 may interconnect with primary channel 222 (e.g., at regular intervals). The one or more secondary channels 223 may extend orthogonally and/or at an angle to primary channel 222 at the point of interconnection. The one or more secondary channels 223 may be straight or may have some curvature (e.g., curving downward as illustrated in FIGS. 2A and 2B). The one or more secondary channels 223 may include one, two, three, four, five, six, seven, eight, nine, ten, or more secondary channels 223 positioned along primary channel 222. While the one or more secondary channels 223 are illustrated at regular intervals (e.g., equally spaced apart), this need not be the case, and this disclosure contemplates irregular intervals.

Inner pole 210 may be equipped with one or more locking handles 225 (e.g., pinned in place to prevent relative motion of the inner pole 210 and the one or more locking handles 225). The one or more locking handles 225 may be secured to inner pole 210 through the one or more slots 221. The one or more locking handles 225 may be configured to engage outer pole 220 and/or the one or more slots 221 to retain inner pole 210 with respect to outer pole 220. This disclosure also contemplates an arrangement where inner pole 210 is stationary and outer pole 220 moves.

During use of the bird feeder apparatus 200, the inner pole 210 may be moved from a retracted position (e.g., as illustrated in FIG. 2A) to an extended position (e.g., as illustrated in FIG. 2B). Thus, a user may grip the one or more locking handles 225 and lift upwardly, which may cause the inner pole 210 to move upwardly with a corresponding motion, and may cause the one or more locking handles 225 to move within primary channel 222.

In order to retain the inner pole 210 at a desired height, the one or more locking handles 225 may be navigated from the primary channel 222 into at least one of the one or more secondary channels 223 until the one or more locking handles 225 reach a stable resting position in the selected secondary channel 223 and inner pole 210 is retained safely in place. Thus, where inner pole 210 and outer pole 220 are of circular cross-section, inner pole 210 may be capable of rotational movement about the longitudinal axis and/or withing outer pole 220.

While FIG. 2B illustrates a locking handle 225 resting within a second of four secondary channels 223, the reader will appreciate that the locking handle 225 may be navigated to any number of secondary channels 223 (e.g., 10 or more secondary channels 223). In this manner, a bird house, bird feeder, or other device for attracting birds may be raised to any height corresponding to the number of secondary channels 223, or may be lowered to the bottom of primary channel 222.

Outer pole 220 may be connected to an upper leveling bracket 231 with a flanged portion 233 which may extend in a plane angularly offset from the longitudinal axis of the bird feeder apparatus 200 (e.g., NOT perpendicular to the longitudinal axis of bird feeder apparatus 200). A lower leveling bracket 235 with a flanged portion 237 may be coupled to flanged portion 233 (e.g., via fasteners, adhesive, welding, clamping, or other means of securement). Flanged portion 237 may extend in a plane perpendicular to the longitudinal axis of lower leveling bracket 235.

A surface fastener 239 may be coupled to the lower leveling bracket 235, and may extend along the longitudinal axis of the lower leveling bracket 235. Thus, the longitudinal axis of the lower leveling bracket 235 may be out of alignment with the longitudinal axis of the bird feeder apparatus 200, corresponding to the angular offset of flanged portion 233 from a plane extending perpendicularly to the longitudinal axis of bird feeder apparatus 200.

During installation of surface fastener 239, it may be difficult to install surface fastener 239 to be perfectly vertically oriented. Therefore, the angular offset of flanged portion 233 may enable the bird feeder apparatus 200 to be installed vertically, or near vertically by rotating the bird feeder apparatus 200 about its longitudinal axis to the most vertical orientation (e.g., to level the device). The orientation may be further adjusted by achieving uneven spacing between flanged portion 233 and flanged portion 237 (such as by adjusting fasteners, adding washers, or utilizing other methods known in the art to achieve uneven spacing). In this way, any misalignment of surface fastener 239 may be corrected to enable the bird feeder apparatus 200 to be vertically oriented (e.g., levelled).

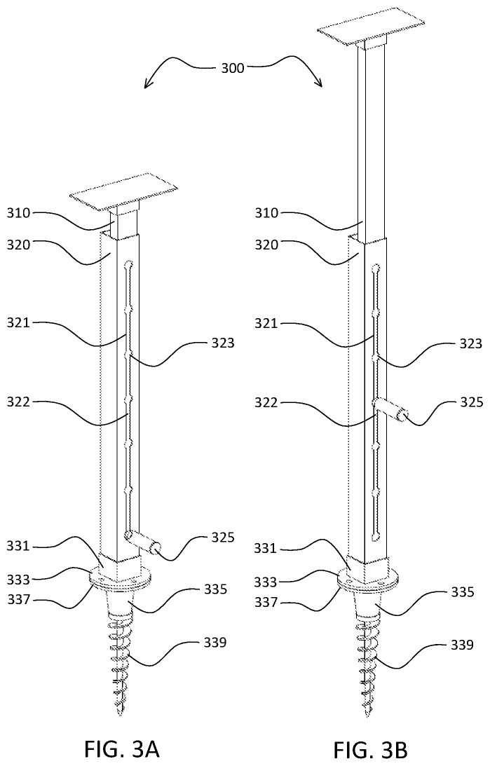

FIGS. 3A and 3B illustrate isometric views of a bird feeder apparatus 300 in a retracted position (e.g., as in FIG. 3A) and in an extended position (e.g., as in FIG. 3B). The apparatus 300 may include an inner pole 310 and an outer pole 320. The inner pole 310 and outer pole 320 may be configured to move with respect to each other, and may be configured to move translationally with respect to each other (e.g., telescopically). Outer pole 320 may be fixed in place (e.g., stationary), and inner pole 310 may be slidingly configured relative to outer pole 320. While inner pole 310 has been represented as the moving pole and outer pole 320 has been represented as the stationary pole, the inverse configuration is contemplated by this disclosure.

Outer pole 320 may be equipped with one or more slots 321. The one or more slots 321 may extend from an outer surface of outer pole 320 to an inner surface of outer pole 320 (e.g., entirely through a side wall of outer pole 320). The one or more slots 321 may include a primary channel 322 and one or more secondary channels 323. Primary channel 322 may extend vertically along the bird feeder apparatus 300 and/or may extend along a longitudinal axis of the bird feeder apparatus 300. Primary channel 322 may be straight.

The one or more secondary channels 323 may interconnect with primary channel 322 (e.g., at regular intervals). The one or more secondary channels 323 may extend on either side of primary channel 322 at the point of interconnection (e.g., having a larger dimension). The one or more secondary channels 323 may be any shape that enables secondary channels to extend beyond the dimensions of primary channel 322 (e.g., circular, as illustrated in FIGS. 3A and 3B). While the one or more secondary channels 323 are illustrated having a circular shape, any other shape may be suitable (e.g., triangular, square, rectangular, or polygonal of 5 or more sides). The one or more secondary channels 323 may include one, two, three, four, five, six, seven, eight, nine, ten, or more secondary channels 323 positioned along primary channel 322. While the one or more secondary channels 323 are illustrated at regular intervals (e.g., equally spaced apart), this need not be the case, and this disclosure contemplates irregular intervals.

Inner pole 310 may be equipped with one or more locking handles 325. The one or more locking handles 325 may be secured to inner pole 310 through the one or more slots 321. The one or more locking handles 325 may be fixed against movement with respect to inner pole 310 along a longitudinal axis of bird feeder apparatus 300, but may be configured to enable movement in a direction orthogonal to the longitudinal axis of the bird feeder apparatus 300 (e.g., between a retracted position and an extended position). The one or more locking handles 325 may be configured to engage outer pole 320 and/or the one or more slots 321 to retain inner pole 310 with respect to outer pole 320. This disclosure also contemplates an arrangement where inner pole 310 is stationary and outer pole 320 moves.

During use of the bird feeder apparatus 300, the inner pole 310 may be moved from a retracted position (e.g., as illustrated in FIG. 3A) to an extended position (e.g., as illustrated in FIG. 3B). When not in use, the one or more locking handles 325 may be engaged by at least one of the secondary channels 323 to prevent relative motion of inner pole 310 and outer pole 320. A user may grip the one or more locking handles 325 and pull orthogonally (e.g., outwardly) to move the one or more locking handles from a retracted position to an extended position (e.g., disengaging the locking handle 325 from the corresponding secondary channel 323). The user may lift upwardly, which may cause the inner pole 310 to move upwardly with a corresponding motion, and may cause the one or more locking handles 325 to move within primary channel 322.

In order to retain the inner pole 310 at a desired height, the one or more locking handles 325 may be navigated into at least one of the one or more secondary channels 323 until the one or more locking handles 325 reengage at least one of the secondary channels 323 and inner pole 310 is retained safely in place. Movement of the one or more locking handles 325 from the retracted position to the extended position may be provided for by an external force applied by the user, whereas movement of the one or more locking handles 325 from the extended position to the retracted position may be provided for by an external force, a magnetic force, a spring, or other system for causing movement back into the retracted position.

While FIG. 3B illustrates a locking handle 325 resting within a fourth of seven secondary channels 323, the reader will appreciate that the locking handle 325 may be navigated to any number of secondary channels 323 (e.g., 10 or more secondary channels 323). In this manner, a bird house, bird feeder, or other device for attracting birds may be raised to any height corresponding to the number of secondary channels 323, or may be lowered to the bottom of primary channel 322.

Outer pole 320 may be connected to an upper leveling bracket 331 with a flanged portion 333 which may extend in a plane orthogonal the longitudinal axis of the bird feeder apparatus 300. A lower leveling bracket 335 with a flanged portion 337 may be coupled to flanged portion 333 (e.g., via fasteners, adhesive, welding, clamping, or other means of securement). Flanged portion 337 may extend in a plane perpendicular to the longitudinal axis of lower leveling bracket 335. A surface fastener 339 may be coupled to the lower leveling bracket 335, and may extend along the longitudinal axis of the lower leveling bracket 335. Thus, the longitudinal axis of the lower leveling bracket 335 may be in alignment with the longitudinal axis of the bird feeder apparatus 300. While the leveling bracket 331 has been illustrated as orthogonal to the longitudinal axis of the bird feeder apparatus 300, this need not be the case, and may be angled as illustrated in other figures of the present invention.

During installation of surface fastener 339, it may be difficult to install surface fastener 339 to be perfectly vertically oriented. Therefore, an angular offset between flanged portion 333 and flanged portion 337 may enable the bird feeder apparatus 300 to be installed vertically (e.g., levelled), such as by achieving uneven spacing between flanged portion 333 and flanged portion 337 (such as by adjusting fasteners, adding washers, or utilizing other methods known in the art to achieve uneven spacing). In this way, any misalignment of surface fastener 339 may be corrected to enable the bird feeder apparatus 300 to be vertically oriented (e.g., levelled).

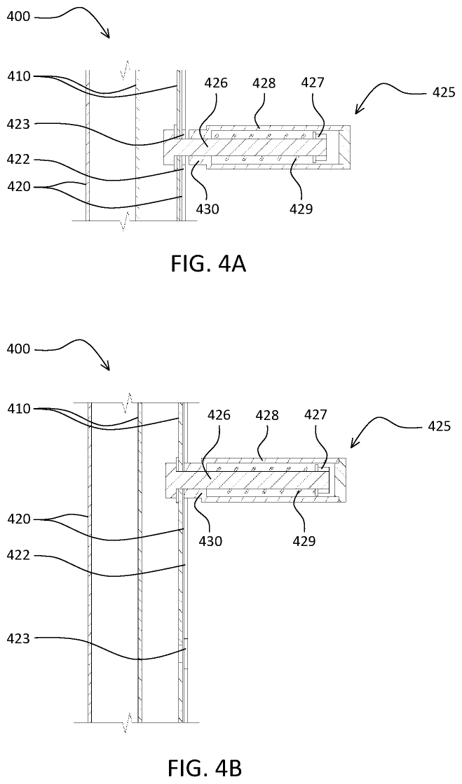

FIGS. 4A and 4B illustrate cross-sectional views of a bird feeder apparatus 400 unsecured by a locking handle 425 (e.g., as in FIG. 4A) and secured by a locking handle 425 (e.g., as in FIG. 4B). The bird feeder apparatus 400 may include an outer pole 420 and an inner pole 410 extending within outer pole 420. Inner pole 410 may be smaller in dimension than outer pole 420 to enable inner pole 410 to move freely within outer pole 420. Inner pole 410 may be only slightly smaller in dimension than outer pole 420, or may be substantially smaller (e.g., inner pole 410 may be approximately half the dimension of outer pole 420 or less).

Outer pole 420 may be equipped with a primary channel 422 and one or more secondary channels 423. Primary channel 422 and the one or more secondary channels 423 may extend from an outer surface of outer pole 420 to an inner surface of outer pole 420 (e.g., entirely through a side wall of outer pole 420). The cross-section of FIGS. 4A and 4B may illustrate a cross-sectional plane passing through a central axis of the primary channel 422 and/or the one or more secondary channels 423.

Primary channel 422 may extend vertically along the bird feeder apparatus 400 and/or may extend along a longitudinal axis of the bird feeder apparatus 400 (e.g., vertically). Primary channel 422 may be straight. The one or more secondary channels 423 may interconnect with primary channel 422 (e.g., at regular intervals), and may have a larger dimension than primary channel 422 (e.g., extending outwardly on either or both sides of primary channel 422).

Inner pole 410 may be equipped with a locking handle 425. The locking handle 425 may be connected to inner pole 410 through primary channel 422 and/or the one or more secondary channels 423. The locking handle 425 may be fixed against movement with respect to inner pole 410 along a longitudinal axis of bird feeder apparatus 400, but may be configured to enable movement in a direction orthogonal to the longitudinal axis of the bird feeder apparatus 400 (e.g., between a retracted position and an extended position). The locking handle 425 may be fixed to inner pole 410 by an inner pin 426.

Inner pin 426 may be secured to inner pole 410 by threaded engagement, adhesive, weld, or other suitable means. Inner pin 426 may extend outward from inner pole 410 and may extend through primary channel 422 and/or the one or more secondary channels 423 of outer pole 420, and may extend outwardly from outer pole 420. An outer shaft 428 and/or a spring 429 may extend over and/or around inner pin 426. A cap 427 may be secured to inner pin 426 (e.g., at an end of inner pin 426 opposite to inner pole 410). Spring 429 may operate to push outer shaft 428 away from cap 427 and/or toward outer pole 420.

Outer pole 420 may have a dimensioned tip 430 which may be dimensioned to approximately match the size and dimension of the one or more secondary channels 423, such that locking handle 425 may be configured to engage outer pole 420 and/or the one or more secondary channels 423 to retain inner pole 410 with respect to outer pole 420. This disclosure also contemplates an arrangement where inner pole 410 is stationary and outer pole 420 moves.

During use of locking handle 425, spring 429 may bias tip 430 into a secondary channel 423 (e.g., a retracted position), such as by applying a force against cap 427 and against an inside surface of outer shaft 428 (e.g., spring 429 may be compressed between cap 427 and outer shaft 428 so as to exert a force). Cap 427 may be fixed, whereas outer shaft 428 may be configured to move (e.g., translate) along inner pin 426. A user may grip outer shaft 428 and may apply a force on outer shaft 428 which opposes and exceeds the force exerted by spring 429, such that outer shaft 428 may move (e.g., translate) away from outer pole 420, causing tip 430 to move out of secondary channel 423 (e.g., an extended position).

In the extended position, inner pole 410 may be free to slide (e.g., telescopically and/or rotationally) within outer pole 420. Thus, a user may apply a second force along a direction parallel to the longitudinal axis of the bird feeder apparatus 400 to cause inner pole 410 to move with respect to outer pole 420 (e.g., lifting or lowering inner pole 410 with respect to outer pole 420). The user may reduce or eliminate the force exerted on outer shaft 428, which may enable spring 429 to push outer shaft 428 toward outer pole 420. If tip 430 is aligned with a secondary channel 423, tip 430 may enter secondary channel 423 and inner pole 410 may be secured with respect to outer pole 420.

If tip 430 is not aligned with a secondary channel 423, tip 430 may contact a side wall of outer pole 420 (e.g., as pushed by spring 429), and inner pole 410 may remain unsecured with respect to outer pole 420. Thus, a complete release of all forces exerted on outer shaft 428 may cause inner pole 410 to fall downward (e.g., due to gravity) until tip 430 aligns with the next lower secondary channel 423 (e.g., as illustrated in FIG. 4B), such that inner pole 410 may be prevented from dropping to the bottom of primary channel 422.

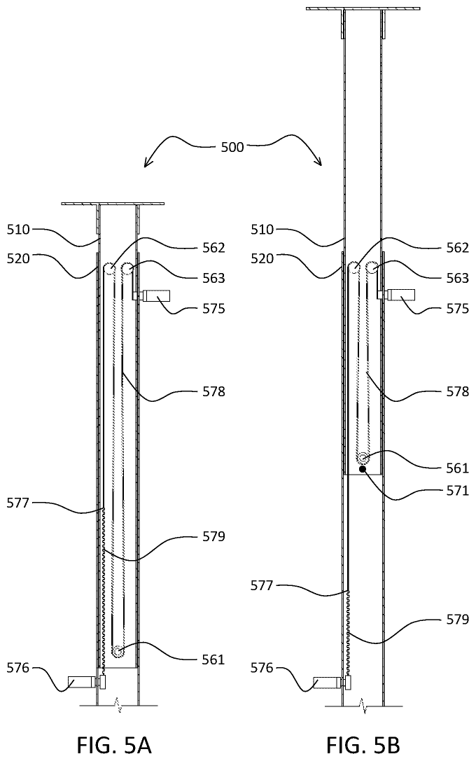

FIGS. 5A and 5B illustrate cross-sectional views of a bird feeder apparatus 500 in a retracted position (e.g., as in FIG. 5A) and in an extended position (e.g., as in FIG. 5B). Bird feeder apparatus 500 may include an inner pole 510 and an outer pole 520 configured such that the inner pole 510 may slide (e.g., telescopically) within outer pole 520. Bird feeder apparatus 500 may include a lift system to assist with, or offset the weight of a bird feeder, bird house, or other device for attracting birds (e.g., where such bird feeder, bird house, or other device for attracting birds is coupled to the top end of inner pole 510).

The lift system may include one or more pulleys 561-563, one or more locking handles 575-576, and one or more links (e.g., cords, springs, ties, links, elastic tubing, flexible tubing, or other connectors). The links may include a first link 578 (e.g., a cord) and/or a second link 579 (e.g., a spring). Where two links are used, they may be secured together at an elastic boundary 577 (e.g., the two links secured together using any fastener described in this disclosure). The one or more locking handles 575 may be secured to outer pole 520, such as at a top or at a bottom of outer pole 520 (e.g., on opposing sides of outer pole 520). The one or more locking handles 575 may be configurable along a primary channel at any number of secondary channels as heretofore presented in this disclosure. The link or links may be secured to ends of the one or more locking handles 575 extending into the inside of outer pole 520. The one or more locking handles 575 may further extend into the inside of inner pole 510, or inner pole 510 may be significantly smaller in dimension than outer pole 520 to enable the lift system to fit in the interior of outer pole 520 but outside of inner pole 510.

The one or more pulleys 561 may be secured to one or both of inner pole 510 and outer pole 520. A first of the one or more pulleys 561 may be secured at or near a bottom end of inner pole 510. With the placement of only a single pulley 561 on the inner pole 510, the one or more locking handles may be configured above the first pulley 561 (e.g., above the first pulley 561 in both the retracted and extended positions). A link (e.g., an elastic cord) may extend from a first locking handle downward around the first pulley 561 and upward to a second locking handle. In the extended position the link may be under tension (e.g., stretched) as much as would happen naturally due to gravity pulling downward the weight of the inner pole 510 and corresponding bird feeder, bird house, or other bird attracting apparatus. Nevertheless, inner pole 510 may be lifted to an extent that the first pulley 561 rises above the link, or inner pole 510 may be forced downward (e.g., by an external force provided by a user) and secured in the retracted position (e.g., where the link is under increased tension and greater stretching). Thus, the force sustained by the link while under tension will be shared by two segments of the link (e.g., each segment on either side of the first pulley 561).

With the placement of a second pulley 562 on outer pole 520 (e.g., illustrated as floating above locking handle 575 but understood to be secured to the outer pole 520), a link may extend from a first locking handle 575 positioned near a top of outer pole 520 (e.g., near second pulley 562) downward around first pulley 561, then upward around second pulley 562, then downward to a second locking handle 576. Thus, the force sustained by the link while under tension will be shared by three segments of the link. Further, the link may be longer to enable greater stretching.

With the placement of a third pulley 563 on outer pole 520 (e.g., illustrated as floating above locking handle 575 but understood to be secured to the outer pole 520), a link may extend from a first locking handle 575 positioned anywhere below the third pulley 563 (e.g., near second pulley 562) upward around third pulley 563, then downward around first pulley 561, then upward around second pulley 562, then downward to a second locking handle 576 (as illustrated in FIGS. 5A and 5B). Thus, the force sustained by the link while under tension will be shared by four segments of the link. Further, the link may be longer to enable greater stretching.

Further, a second link may be incorporated into any of the above designs. In general, it is understood that the elasticity of the first link and the elasticity of the second link may be similar or different. Further, one link may be optimally selected to provide a force which counterbalances the weight of inner pole 510 and any apparatus mounted thereon (e.g., selected to offset at least a portion of the weight of inner pole 510), whereas the other link may be optimally selected to easily flex around the one or more pulleys 561-563. In this way, elastic boundary 577 represents a position in the linkage combination where elasticity, flexibility, or other design parameters can be altered to optimize the performance of the system.

Thus, a first link 578 (e.g., an elastic cord) may extend from a first locking handle 575 upward around the third pulley 563, then downward around the first pulley 561, then upward around the second pulley 562, then downward to the elastic boundary 577. A second link 579 (e.g., a spring) may be coupled to the first link at the elastic boundary 577 and may extend downwardly to a second locking handle 576. First link 578 and second link 579 may each be stretched and compressed by movement of inner pole 510 with respect to outer pole 520, yet the degree to which each link experiences stretching may be optimized by material selection. Thus, it may be desirable for the second link 579 to stretch up to a predetermined threshold (e.g., where the second link is a spring, it may be desirable to prevent the second link from extending around any of the one or more pulleys 561-563).

During use of the lift system a user may adjust the amount of ballast, or counterbalance provided by the lift system by moving the one or more locking handles 575-576 upward or downward (e.g., stretching or retracting the one or more links 578-579 differently) before adjusting the height of the inner pole 510 as heretofore presented in this disclosure. Further, the inner pole 510 may be lifted from the retracted to the extended position (e.g., or lowered from the extended position to the retracted position) incrementally, by adjusting at least one locking handle (e.g., locking handle 575) then adjusting a locking handle associated with the inner pole 510 (e.g., locking handle 325 of FIG. 3A), then repeating these steps until the inner pole 510 attains the desired height. This method may have the effect of minimizing the difficulty of raising or lowering the bird feeder apparatus 500, reducing the amount of force needed to raise or lower the bird feeder apparatus 500, and/or eliminating the need for the user to bend over or otherwise use uncomfortable or unergonomic positions during use of the bird feeder apparatus 500.

While the disclosure contemplates one or more locking handles 575-576, a locking position may be used interchangeably with either or all locking handles (e.g., where an end of the link is fixed and non-adjustable within outer pole 520). While not represented in FIG. 5A or 5B, it is understood that locking handles 575-576 may be adjustable in any manner as taught by this disclosure.

While only up to three pulleys 561-563 have been represented in FIGS. 5A and 5B, this disclosure contemplates the use of additional pulleys (e.g., 1, 2, 3, 4, 5, or more additional pulleys). While second pulley 562 and third pulley 563 have been illustrated in close proximity to each other and first pulley 561 located far away, this disclosure contemplates other orientations, symmetrical or asymmetrical, beyond those illustrated in the figures.

While FIGS. 5A and 5B seem to illustrate relatively little elongation of second link 579 and relatively greater elongation of first link 578 as between the retracted and extended positions of inner pole 510, this disclosure contemplates any combinations wherein second link 579 provides stretching up to the distance between the second pulley 562 and the second locking handle 576, the first link provides all the stretching, there is only one link, or any combination of stretching between the first, second, or any additional link. Furthermore, this disclosure contemplates more than one lift system, where each lift system operates simultaneously or each lift system operates during a discrete portion of the relative motion of inner pole 510 with respect to outer pole 520. While inner pole 510 has been represented as the moving pole and outer pole 520 has been represented as the stationary pole, the inverse configuration is contemplated by this disclosure.

A post 571 may be coupled adjacent to first pulley 561, which may be positioned to prevent the first link 578 from being dislodged from first pulley 561. While additional posts have not been illustrated adjacent to second pulley 562 and third pulley 563, this disclosure contemplates the use of additional posts at each pulley and/or a plurality of posts at each pulley to prevent dislodgement of the linkage (e.g., during installation, lifting, lowering or other use).

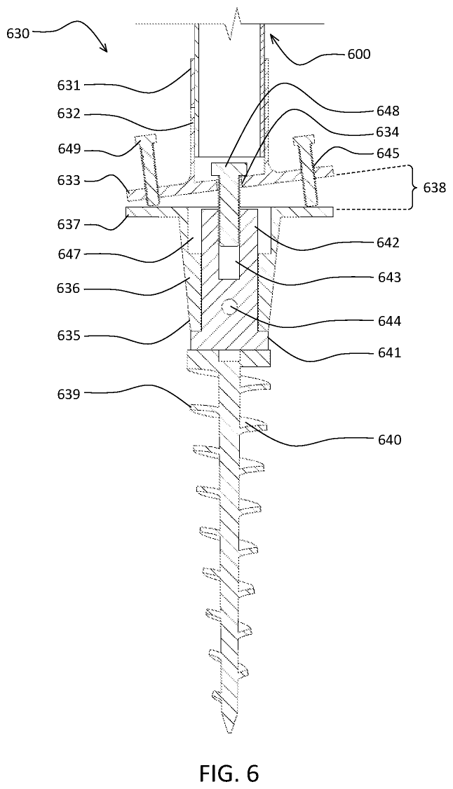

FIG. 6 illustrates a retaining mechanism 630 of a bird feeder apparatus 600. The retaining mechanism 630 may be coupled to an outer pole of the bird feeder apparatus 600 (e.g., outer pole 120 of FIG. 1). Retaining mechanism 630 may include an upper leveling bracket 631, a lower leveling bracket 635, and a surface fastener 639. Surface fastener 639 may have an auger element 640 with a helical flange to enable drilling the auger element 640 into the ground.

Surface fastener 639 may have a tool element 641 to enable interconnection with a tool for drilling surface fastener 639 into the ground (e.g., a power tool). Tool element 641 and auger element 640 may be secured against movement with respect to each other (e.g., via a set screw, pin, screw, latch, clamp, adhesive, hook and loop fastening, threading, being formed integrally during manufacture, or other means of securement). Tool element 641 may have an upper portion 642 resembling a particular shape to interconnect with a corresponding shape of the drilling tool. The particular shape may be any of a square, a triangle, a hexagon, a star, or other shape configured to reduce slipping between the tool element 641 and the drilling tool during operation of the drilling tool.

Surface fastener 639 may be configured to be secured to, interconnect with, or otherwise be retained to a lower leveling bracket 635 and/or an upper leveling bracket 631. Thus, tool element 641 of surface fastener 639 may include a central bore 643 (e.g., a threaded bore) for attachment to the upper leveling bracket 631 and/or an orthogonal bore 644 (e.g., a threaded bore) for attachment to the lower leveling bracket 635.

Lower leveling bracket 635 may be configured with a support portion 636 and a flanged portion 637. Support portion 636 may be configured to enclose tool element 641, and may be secured to tool element 641 by any securement means (e.g., a bolt, screw, detent, formed integrally, or other connection method). Thus, a bolt (e.g., a countersunk bolt) may extend through support portion 636 (e.g., through a countersunk aperture) into orthogonal bore 644 of tool element 641. A tool gap 647 may extend between upper portion 642 of tool element 641 and support portion 636 of lower leveling bracket 635 to enable interconnection with a tool for drilling surface fastener 639 into the ground (e.g., a power tool). Flanged portion 637 may extend in a plane perpendicular to the longitudinal axis of lower leveling bracket 635 (e.g., as illustrated in FIG. 6), or flanged portion 637 may extend in a plane having an angular offset from a plane perpendicular to the longitudinal axis of lower leveling bracket 635.

Upper leveling bracket 631 may be configured with a support portion 632 and a flanged portion 633. Support portion 632 may be configured to be secured to, interconnect with, or otherwise be retained to the outer pole (e.g., outer pole 120 of FIG. 1). Flanged portion 633 may extend in a plane perpendicular to the longitudinal axis of upper leveling bracket 631, or flanged portion 633 may extend in a plane having an angular offset from a plane perpendicular to the longitudinal axis of upper leveling bracket 631 (e.g., as illustrated in FIG. 6).

In general, flanged portion 633 is understood to be configured to be secured to, interconnect with, or otherwise be retained against flanged portion 637. To affect this coupling, a central connector 648 (e.g., a bolt) may extend through a central aperture 634 of upper leveling bracket 631, and may extend into the central bore 643 of tool element 641. Central connector 648 may be tightened until flanged portion 633 of upper leveling bracket 631 contacts flanged portion 637 of lower leveling bracket 635 (e.g., retained by friction and/or compression). One or more perimeter connectors 649 (e.g., threaded connectors) may extend through one or more perimeter apertures 645 (e.g., threaded apertures). The one or more perimeter connectors 649 may be tightened until the lower tips thereof contact flanged portion 637 of lower leveling bracket 635 (e.g., as illustrated in FIG. 6). The one or more perimeter connectors 649 may further include retaining means to prevent loosing over time or in response to vibration or other environmental conditions (e.g., retaining means such as compression springs, lock nuts, thread locking, or other means of retainment).

Such an arrangement of perimeter connectors may enable the flanged portion 633 of upper leveling bracket 631 to be retained at an angle 638 to flanged portion 637 of lower leveling bracket 635. While at least one perimeter connector will enable an angle 638, any number of perimeter connector are contemplated by this disclosure to provide adequate strength and integrity to the retaining mechanism 630 (e.g., 1, 2, 3, 4, 5, 6, 7, 8, 9, 10, or more perimeter connectors).

Furthermore, such an arrangement may be designed to correct up to a specified amount of misalignment between the longitudinal axis of the upper leveling bracket 631 and the longitudinal axis of the lower leveling bracket 635 (e.g., between about 0 degrees and about 45 degrees). Thus, it is contemplated that flanged portion 633 may be angled with respect to a plane extending perpendicular to the longitudinal axis of the upper leveling bracket 631, flanged portion 637 may be angled with respect to a plane extending perpendicular to the longitudinal axis of the lower leveling bracket 635, or both (e.g., doubling the extent of misalignment that may be corrected for).

Where surface fastener 639 may have been coupled to a surface at some angular offset from a vertical direction, the angular offset, or misalignment, may be corrected in a number of ways. Where flanged portion 637 is angled, surface fastener 639 may be reoriented to position flanged portion 637 as close to the horizontal plane as possible (e.g., continued drilling). Where flanged portion 637 is angled, lower leveling bracket 635 may be rotated (e.g., rotating support portion 636 with respect to tool element 641) to position flanged portion 637 as close to the horizontal plane as possible. Where flanged portion 633 is angled, upper leveling bracket 631 may be rotated to position flanged portion 633 as close to the horizontal plane as possible. Where flanged portion 633 and flanged portion 637 are angled, upper leveling bracket 631 may be rotated to position flanged portion 633 as close to the horizontal plane as possible and lower leveling bracket 635 may be positioned so that flanged portion 637 is as close to the horizontal plane as possible. Upon achieving the desired orientations, central connector 648 and perimeter connectors 649 (if needed) may be secured as described in this disclosure.

Though not shown, it may be advantageous to equip the various fastening means presented in this disclosure with locking devices (e.g., a bolt may be equipped with a lock nut, or nut and lock washer combination) to prevent loosening of components over time. Furthermore, while particular types of fastening systems may have been discussed with regard to interconnections of components in this disclosure, this disclosure also contemplates the use of each and every fastening system mentioned and those known in the art for the interconnections discussed in this disclosure.

During assembly and/or installation of the bird feeder apparatus 600, a user may: (i) securely couple the surface fastener 639 to a surface; (ii) securely couple the lower leveling bracket 635 to the surface fastener 639 in the desired orientation; (iii) loosely couple the upper leveling bracket 631 to the surface fastener (e.g., to the tool element 641) with the central connector 648; (iv) securely couple the upper leveling bracket 631 to the bird feeder apparatus 600 (e.g., to outer pole 120 of FIG. 1); (v) rotate bird feeder apparatus 600 until upper leveling bracket 631 achieves the desired orientation; (vi) extend perimeter connectors 649 through flanged portion 633 until either (a) perimeter connectors 649 cause bird feeder apparatus 600 to be held vertically, (b) at least one perimeter connector 649 is fully extended, or (c) the perimeter connectors 649 are extended until they are tight and bird feeder apparatus 600 is held securely; (vii) remove bird feeder apparatus 600 and tighten central connector 648, if needed; and/or (viii) securely couple the upper leveling bracket 631 to the bird feeder apparatus 600.

While the above steps have been represented in the specified order, it is understood that the order represented may be helpful during assembly and/or installation, but is not absolutely required. Furthermore, in the event that surface fastener 639 is secured to the surface with an angular offset too great to be corrected, the user may opt to remove, or disconnect, the surface fastener 639 from the surface and make a second attempt to achieve connection within the optimum permissible misalignment to enable the bird feeder apparatus 600 to be installed vertically.

Other aspects will be apparent to those skilled in the art from consideration of the specification and practice disclosed herein. It is intended, therefore, that the specification and illustrated embodiments be considered as examples only.

1. A bird feeder apparatus comprising:
a retaining mechanism having a surface fastener configured to be directly coupled to a surface, the retaining mechanism having an upper leveling bracket coupled to the surface fastener, the upper leveling bracket having a flanged portion, the retaining mechanism having a lower leveling bracket retained by the upper leveling bracket and the surface fastener, the lower leveling bracket having a flanged portion, wherein one or more perimeter connectors extend between the flanged portions, respectively, to push the flanged portions into an angular offset with respect to each other, wherein the upper leveling bracket and the lower leveling bracket may be moved with respect to each other to level the bird feeder apparatus;
a stationary pole coupled to the upper leveling bracket, the stationary pole having one or more slots; and
a moving pole coupled to the stationary pole, the moving pole capable of movement with respect to the stationary pole, the moving pole having a handle coupled to the moving pole and extending through the one or more slots.

2. The bird feeder apparatus of claim 1, wherein a central connector couples the upper leveling bracket to the surface fastener.

3. The bird feeder apparatus of claim 1, wherein the flanged portion of the upper leveling bracket and the flanged portion of the lower leveling bracket are pushed into an angular offset of between 0 and 20 degrees.

4. The bird feeder apparatus of claim 1, wherein the moving pole is configured within the stationary pole.

5. The bird feeder apparatus of claim 1, wherein the one or more slots includes a primary channel and one or more secondary channels, and wherein the handle is moveable along the primary channel and securable within the secondary channels.

6. The bird feeder apparatus of claim 5, wherein movement of the handle along the primary channel corresponds to movement of the moving pole between a retracted position and one or more extended positions.

7. The bird feeder apparatus of claim 5, wherein movement of the handle along the one or more secondary channels corresponds to securing the moving pole against movement with respect to the stationary pole.

8. The bird feeder apparatus of claim 5, wherein the handle is moveable in a direction orthogonal to movement of the moving pole between a retracted position within the one or more secondary channels and an extended position out of the one or more secondary channels.

9. A bird feeder apparatus comprising:
a moving pole;
a stationary pole coupled to the moving pole, such that the moving pole is capable of movement with respect to the stationary pole; and
a retaining mechanism including an upper leveling bracket coupled to the stationary pole, the upper leveling bracket having a flanged portion, a surface fastener coupled to the upper leveling bracket, and a lower leveling bracket retained by the upper leveling bracket and the surface fastener, the lower leveling bracket having a flanged portion, the surface fastener configured to be directly coupled to a surface, wherein one or more perimeter connectors extend between the flanged portions, respectively, to push the flanged portions into an angular offset with respect to each other, wherein the upper leveling bracket and the lower leveling bracket may be moved with respect to each other to level the bird feeder apparatus.

10. The bird feeder apparatus of claim 9, wherein the stationary pole has one or more slots, and wherein the moving pole has a handle coupled to the moving pole and extending through the one or more slots.

11. The bird feeder apparatus of claim 9, wherein the bird feeder apparatus further includes a lifting device, the lifting device including one or more links secured to the stationary pole and extending around one or more pulleys secured to one or both of the stationary pole and the moving pole, the one or more links acting to offset at least a portion of a weight of the moving pole.

12. The bird feeder apparatus of claim 11, wherein the one or more pulleys includes a first pulley mounted on the moving pole and second and third pulleys mounted on the stationary pole.

13. The bird feeder apparatus of claim 12, wherein the one or more links includes a first link extending from a first securement point around the third pulley, then around the first pulley, then around the second pulley to a second link, the second link extending from the first link to a handle configured for adjustment within a slot.

14. The bird feeder apparatus of claim 9, wherein a central connector couples the upper leveling bracket to the surface fastener.

15. The bird feeder apparatus of claim 9, wherein the flanged portion of the upper leveling bracket and the flanged portion of the lower leveling bracket are pushed into an angular offset of between 0 and 30 degrees.

16. The bird feeder apparatus of claim 9, wherein a central connector couples the upper leveling bracket to the surface fastener.

17. The bird feeder apparatus of claim 9, wherein the stationary pole is configured within the moving pole.

18. A bird feeder apparatus comprising:
a retaining mechanism including a surface fastener configured to be directly coupled to a surface, an upper leveling bracket coupled to the surface fastener, a lower leveling bracket retained by the upper leveling bracket and the surface fastener, the upper and lower leveling brackets having flanged portions, respectively, wherein the flanged portions are pushed into an angular offset with respect to each other to level the bird feeder apparatus;
a stationary pole coupled to the upper leveling bracket, the stationary pole having one or more slots; and
a moving pole coupled to the stationary pole, the moving pole capable of movement with respect to the stationary pole, the moving pole having a handle coupled to the moving pole and extending through the one or more slots.

19. The bird feeder apparatus of claim 18, wherein the one or more slots includes a primary channel and one or more secondary channels, and wherein the handle is moveable along the primary channel and securable within the secondary channels.

20. The bird feeder apparatus of claim 18, wherein the bird feeder apparatus further includes a lifting device, the lifting device including one or more links secured to the stationary pole and extending around one or more pulleys secured to one or both of the stationary pole and the moving pole, the one or more links acting to offset at least a portion of a weight of the moving pole.
